(19) United States
(12) Patent Application Publication
(10) Pub. No.: US 2025/0095872 A1
(43) Pub. Date: Mar. 20, 2025

(54) PASSIVE COOLANT MANAGEMENT

(71) Applicant: Tokamak Energy Ltd, Abingdon Oxfordshire (GB)

(72) Inventors: Robert Bamber, Abingdon Oxfordshire (GB); Patrick Bunting, Abingdon Oxfordshire (GB); Jack Taylor, Abingdon Oxfordshire (GB)

(21) Appl. No.: 18/707,522

(22) PCT Filed: Nov. 3, 2022
(86) PCT No.: PCT/EP2022/080647

§ 371 Date: May 3, 2024

(30) Foreign Application Priority Data
Nov. 5, 2021 (GB) 2115933.0

(51) Int. Cl. G21B 1/13; G21B 1/05

(52) U.S. Cl. CPC G21B 1/13; G21B 1/05

(57) ABSTRACT

A cooling management system for a plasma-facing assembly in a magnetic confinement plasma chamber, the cooling management system comprising: a plurality of coolant unit groups, each configured to provide cooling to a respective part of the plasma-facing assembly and being fluidly connected to a coolant source line; and a valve arrangement operable to control a flow rate of coolant from the coolant source line to each of the coolant unit groups dependent on the temperature at that coolant unit group.

### FIELD OF THE INVENTION

The present invention relates to a cooling management system for a tokamak.

### BACKGROUND

A tokamak is a device that uses a magnetic field to confine the plasma within a plasma vessel. Tokamaks have a divertor, which acts as a heat dump, or, exhaust channel for “hot” plasma that is not contained by the magnetic field. For this reason, the divertor is subject to very large heat fluxes.

FIG. 1 shows a poloidal cross section of an exemplary tokamak. The tokamak 100 comprises a toroidal plasma chamber 101. Poloidal magnetic field coils (not shown) produce a poloidal magnetic field, which confines the plasma. The magnetic field lines effectively form toroidally symmetric, nested surfaces to which the plasma (i.e., a “soup” of charged particles) is constrained. These nested surfaces are represented as lines of constant poloidal flux 113 in FIG. 1. Inside these nested surfaces, the plasma is said to be confined inside the “plasma core”. However, via collisions and other such processes, the plasma slowly diffuses out from the plasma core, towards the plasma chamber walls. To reduce interaction with the plasma chamber walls, a poloidal field null 112 (the “X” point) is generated using dedicated shaping coils. The null point 112 causes some flux lines (e.g., flux line 114) to intersect two surfaces below the null point 112: the outboard (i.e., a radially outer) divertor surface 121 and the inboard (i.e., radially inner) divertor surface 122. The flux line that defines the null point 112 (i.e., the flux line that passes through the null) also intersects the outboard and inboard divertor surfaces 121, 122. The location of these intersections is referred to as the “strike point”. At the strike point, the heat flux is at a maximum. For a number of reasons, the position of the null point 112 moves. The strike point on divertor surfaces 121, 122 moves in correspondence.

A typical divertor cooling arrangement 200, such as proposed for ITER, is shown in FIG. 2A and FIG. 2B. FIG. 2A shows a longitudinal cross-section along the cooling channel 202, whereas FIG. 2B shows a transverse cross-section (AA′) across the cooling channel 202. The cooling system 200 comprises: a plurality of tungsten “monoblocks”, each defining an aperture; and a CuCrZr tubing 204, which passes through each aperture in the plurality of tungsten “monoblocks”, thereby defining a channel 202. In operation, the channel 202 transports coolant (e.g., water) from a coolant inlet 208 to a coolant outlet 210 in order to cool the tungsten “monoblocks”. In some examples, there is a buffer layer between the CuCrZr tubing and the tungsten monoblocks (not shown).

A problem with conventional divertor cooling arrangements is that the position of the maximum heat flux (i.e., the strike point) may vary, and hence the position of maximum heat flux at any given time during operation of the tokamak is unknown. Therefore, the heat profile across the divertor is unknown. To prevent overheating, coolant is provided to each cooling channel of the divertor at the flow rate needed to cool the metal temperatures to reasonable temperatures at the maximum heat flux location. This is necessary as the cooling capacity is a relatively strong function of flow rate. A more optimal cooling configuration, which significantly reduces the pumping power and which varies dependent upon the strike position, is desirable.

### SUMMARY

According to a first aspect of the invention, there is provided a cooling management system for a plasma-facing assembly in a magnetic confinement plasma chamber, the cooling management system comprising: a plurality of coolant unit groups, each configured to provide cooling to a respective part of the plasma-facing assembly and being fluidly connected to a coolant source line; and a valve arrangement operable to control a flow rate of coolant from the coolant source line to each of the coolant unit groups dependent on the temperature at that coolant unit group. More optimal cooling configurations are therefore possible.

Each of the coolant unit groups may comprise a conduit configured to supply coolant to its one or more coolant units and each coolant unit comprises a coolant channel configured to provide coolant to a respective area of said part of the plasma facing assembly.

The valve arrangement may include a valve arranged within the conduit of each coolant group.

The plurality of groups in the cooling management system may be either fluidly connected in series or connected in parallel.

The valves in the cooling management system may be either passive or active.

Actively controlled valves can be controlled using a controller configured to actuate each valve further closed or open depending on the temperature. That is, the controller may be configured to further close the valve monotonically between a second predetermined temperature and a first predetermined temperature, or, further open the valve monotonically between the first predetermined temperature and the second predetermined temperature to vary its flow resistance.

The state of the passive valves may passively depend on temperature. That is, each valve is configured to open monotonically as the temperature increases from a first predetermined temperature to a second predetermined temperature to decrease the flow resistance of the valve; and close monotonically as the temperature decreases from a second predetermined temperature to a first predetermined temperature to increase the flow resistance of the valve (without the need of a controller).

The first predetermined temperature may be around 350 to 450° C. and the second predetermined temperature may be around 550 to 650° C.

Optionally, each passive valve comprises one or more stacked expandable elements, having a melting point substantially equal to the second predetermined temperature, such that, when said expandable elements melt, a cap, attached to one end of a rod which is mechanically coupled to said expandable elements, is urged away from a valve seat to open the valve.

Alternatively, each passive valve comprises a structure comprising at least two materials with differing thermal expansion coefficients, wherein the structure is arranged to obstruct flow through the valve to a greater degree at lower temperatures.

Each valve may be located close to the inlet of the corresponding group (i.e., at the junction between the conduit and the coolant source line).

The plasma-facing assembly may be a divertor assembly and each coolant unit may be integrally formed to a portion of a tile of a divertor, or one or more of the tiles of a divertor. Each group may comprise between 100 to 10,000 coolant units, more preferably, 1000 to 5000 coolant units and each group may define an array of tiles on the divertor, the array comprising 10 to 100 divertor tiles along a first transverse direction and 10 to 100 divertor tiles along a second transverse direction.

The cooling management system may further comprise one or more coolant source lines operable to provide coolant in parallel to a different set of the groups of the coolant unit assembly and each set of groups of the coolant unit assembly may comprise 3 to 10 groups.

According to a second aspect of the invention, there is provided a tokamak or stellarator comprising the cooling management system described above.

The tokamak may be a spherical tokamak, and more preferably a spherical tokamak having an aspect ratio of less than or equal to 2.5, the aspect ratio being defined as the ratio of the major and minor radii of a toroidal plasma-confining region of the tokamak.

### BRIEF DESCRIPTION OF THE DRAWINGS

Some embodiments of the invention will now be described by way of example only and with reference to the accompanying drawings, in which:

FIG. 1 shows a poloidal cross section of a tokamak.

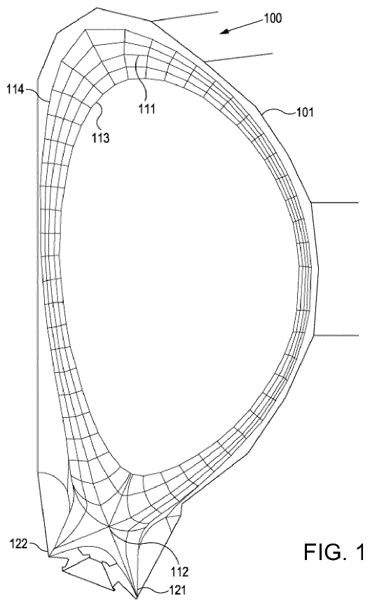

FIG. 2 shows a conventional divertor cooling arrangement.

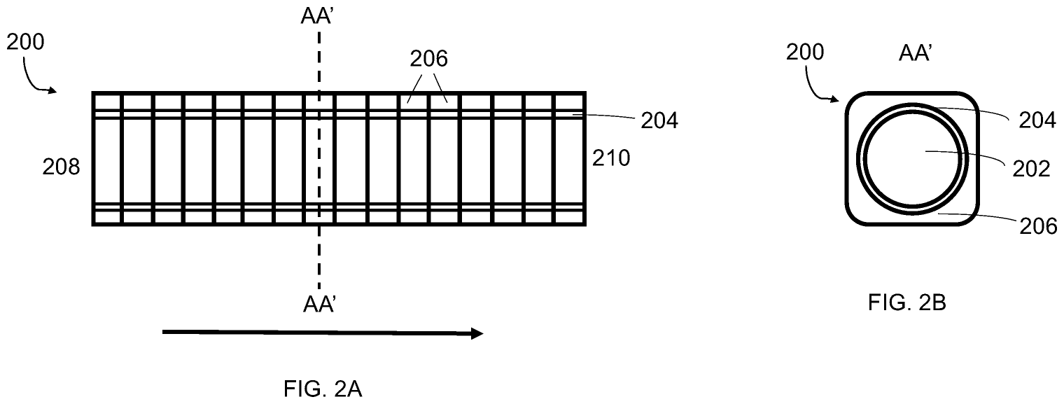

FIG. 3 shows a schematic sectional view of a coolant unit assembly.

FIGS. 4A, 4B and 4C shows a schematic illustration of a cooling management system and a temperature profile before and after the strike point moves.

FIG. 5 shows a flow diagram.

FIGS. 6A, 6B and 6C shows a schematic illustration of a cooling management system and a temperature profile before and after the strike point moves.

FIG. 7 shows a flow diagram.

FIGS. 8A, 8B and 8C show different sectional views of a cooling management system.

FIG. 9A and FIG. 9B show schematic illustrations of exemplary passive valves.

### DETAILED DESCRIPTION

Proposed herein is a new cooling management system that can control the degree of cooling across a region of the divertor target plate in response to a given heat load distribution, such that this heat load is more efficiently accommodated by the divertor through more efficient coolant distribution. In the examples described herein, the cooling management system is used for a divertor, but the cooling management system is equally suitable for other plasma facing components (PFCs). The divertor may be provided within a magnetic confinement plasma chamber, for example of a tokamak, preferably a spherical tokamak. Preferably, but not necessarily, the aspect ratio of the spherical tokamak is less than or equal to 2.5. The aspect ratio is the ratio of the major and minor radii of the toroidal plasma-confining regions of the tokamak. The divertor may also be provided within a stellarator or other plasma confinement system.

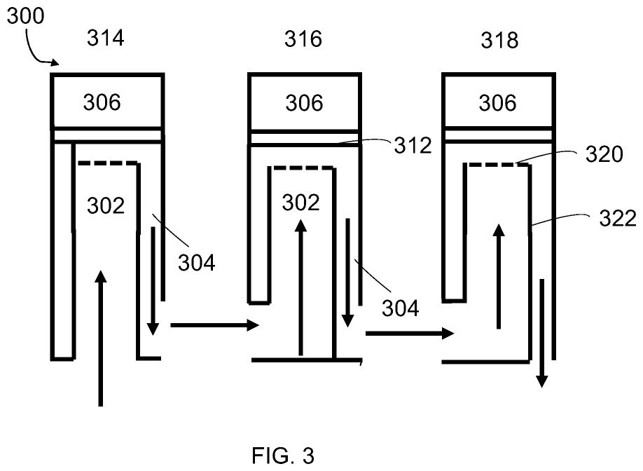

FIG. 3 shows a vertical cross section of an assembly 300 comprising a plurality of “finger units” 314, 316, 318. For illustrative purposes only, each finger unit 314, 316, 318 is separated from its neighbour. A finger unit may also be referred to herein as a “coolant unit”. A finger assembly should be construed accordingly.

Each finger unit 314, 316, 318 comprises: a portion of a divertor tile 306, or one or more divertor tiles 306 brazed or otherwise bonded to a thimble portion 312 of the finger unit 314; and a cartridge 322, which defines at least part of an internal channel 302 for providing coolant close to tiles 306. In some examples, the cartridge 322 is open-ended, whereas, in other examples (and as shown in FIG. 3), the cartridge 322 has a cap, comprising an array of apertures 320 for coolant to flow from the cartridge 322 into the thimble portion 312 of the finger unit 314. The array of apertures 320 may enhance cooling of the divertor tiles 306 via jet cooling.

In the assembly 300, the finger units are fluidly connected in series, such that coolant may flow from the thimble portion 312 of one finger unit 314 into the cartridge 322 of an adjacent finger unit 316 via channel 304. A similar finger unit is described in journal paper: “Status of development of the EU He-cooled divertor for DEMO”, January 2008, Norajitra et al.”

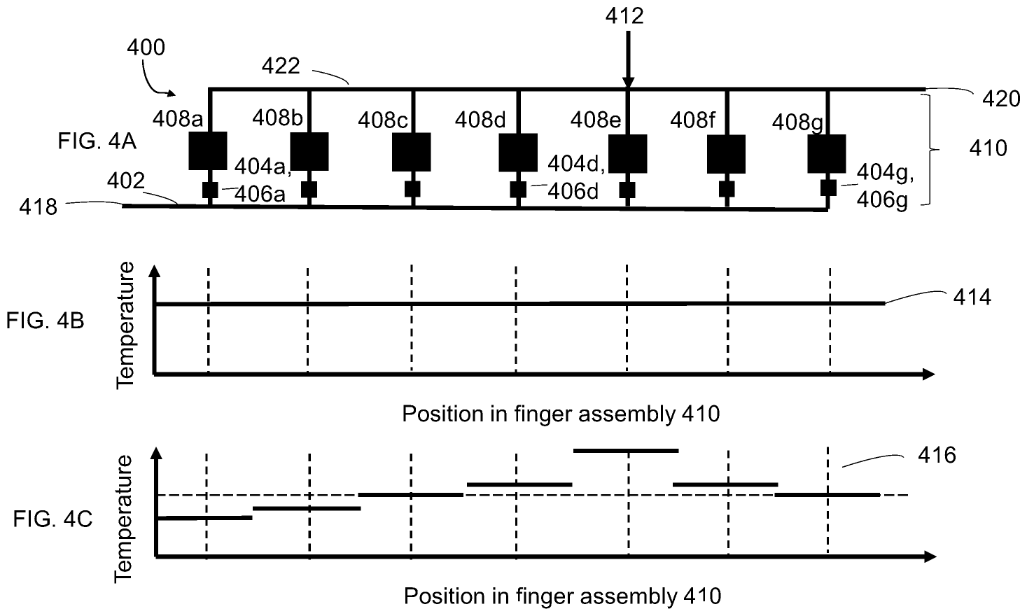

FIG. 4A shows a schematic illustration of a vertical cross section of a cooling management system 400 for a divertor. The cooling management system 400 comprises: a channel 402 configured to provide coolant to each group of finger units 408a-g, wherein each group of finger units comprises a plurality of finger units 314, 316; a plurality of conduits 404a-g, which are configured to fluidly connect channel 402 to the corresponding group of fingers 408a-g; and a plurality of valves 406a-g, each of which is arranged within the corresponding conduit 404a-g and operable to control the flow rate of coolant from channel 402 into the corresponding group of finger units 408a-g. In the schematic illustration, conduits 404a-g are shown to connect channel 402 in different locations; however, in practice, the connection points of conduits 404a-g to channel 402 may be substantially co-located. One or more pumps (not shown) are operable to produce a pressure difference between the inlet 418 of the cooling management system 400 and the outlet 420 of the cooling management system 400 in order to transport coolant through the cooling management system 400. A plurality of the group of fingers units is referred to herein as a finger assembly 410. The finger units 314, 316, 318 in each of the group of fingers 408a-g and the group of fingers 408a-g, or finger assembly 410 may be those shown in FIG. 3. The inlet 418 is also referred to as a coolant source line.

In FIG. 4A, the group of finger units 408a-g are fluidly connected in parallel with one another via channel 402. Each conduit 404a-g fluidly connects channel 402 to an inlet of the corresponding group of finger units 408a-g. An outlet of each group of finger units 408a-g is fluidly connected to the outlet 420 of the cooling management system 400 via a further channel 422.

FIG. 4B shows an exemplary temperature profile 414 along the finger assembly 410, corresponding to an initial divertor heat loading, before the position of the strike point 412 on the divertor changes. For illustrative purposes, the temperature profile 414 along the finger assembly 410 is shown as being constant; however, it should be appreciated that the temperature profile 414 along the finger assembly 410 may be different.

As described in the background section, the position of the strike point 412 on the divertor changes and correspondingly the heat loading conditions incident to the divertor change with time. The change in heat loading perturbs the temperature profile 414 shown in FIG. 4B. As an example, the flow rate of coolant to the finger assembly 410 immediately beneath the new strike point 412 may be too low to prevent heating, whereas the flow rate of coolant to the finger assembly immediately beneath the previous position of the strike point may be too large, leading to cooling.

FIG. 4C shows an exemplary perturbed temperature profile 416 along the finger assembly 410 after the position of the strike point 412 moves (the new position is shown in FIG. 4A). The temperatures shown in FIG. 4C are the average temperatures across each group of fingers units 408a-g. As the skilled reader would appreciate, the temperature profile may differ in practice. In the example shown, the “new” strike point 412 is located in the group of fingers units 408e. Correspondingly, regions of the finger assembly 410 closer to the “new” strike point 412 may experience heating, whereas regions of the finger assembly 410 more distal to the “new” strike point 412 may experience cooling relative to that of the original strike position.

The exact temperature response may depend on:
the history of the system, including:
   the previous position, form and magnitude of the strike point 412; and
   previous flow rates into each group of finger units 408a-g;
the thermal diffusivity of the finger assembly 410; and
any anisotropy present in the thermal diffusivity and previous coolant configuration.

To a first approximation, the temperature profile 416 along the finger assembly 410 is symmetric about the strike point 412 because the heat flux profile is broadly symmetric and each group of finger units 408a-g is fluidly connected in parallel with one another.

In the example shown in FIG. 4C, group of finger units 408a and 408b are “overcooled”, whereas group of finger units 408d, 408e, 408f are “undercooled”. The temperature for the group of finger units 408c, 408g remains largely unchanged. It is an objective of the present disclosure to even out the temperature profile following a shift in the strike point.

When the group of finger units 408a-g are fluidly connected in parallel, the flow rate of coolant into each group 408a-g is related to the relative magnitude of flow resistance of each group 408a-g compared to other groups 408a-g. That is, if group 408a has a lower resistance compared to the other groups 408b-g, the fraction of the total coolant flowing through group 408a is larger than the other groups 408b-g. For example, the fraction of coolant that flows into group 408a is approximately proportionate (e.g. equal) to one minus the ratio between:
i) the total flow resistance of group 408a, conduit 406a and valve 404a; and
i) the total flow resistance of all groups 408a-g, conduits 406a-g and valves 404a-g.

To a first approximation, the resistance of conduits and the outlet 420 may be ignored as being significantly smaller than the resistances of valves 404a-g and the group of finger units 408a-g.

Optionally, each group of finger units 408a-g has an equal inherent resistance to flow (i.e., not counting any contributions from the valves). This may be achieved if each group 408a-g has the same number of equivalent finger units 314, 316, 318, or, where the size and/or configuration of finger units 314, 316, 318 are different, and there are a different number of finger units 314, 316, 318. In some examples, the inherent resistance to flow may be greater in groups further away from any expected strike points (e.g., at the edges of the divertor).

The flow rate into each group 408a-g can be controlled by changing the resistance of the corresponding valve 406a-g fluidly connected to that group 408a-g. For example, by actuating the valve 406a-g open or closed to varying degrees.

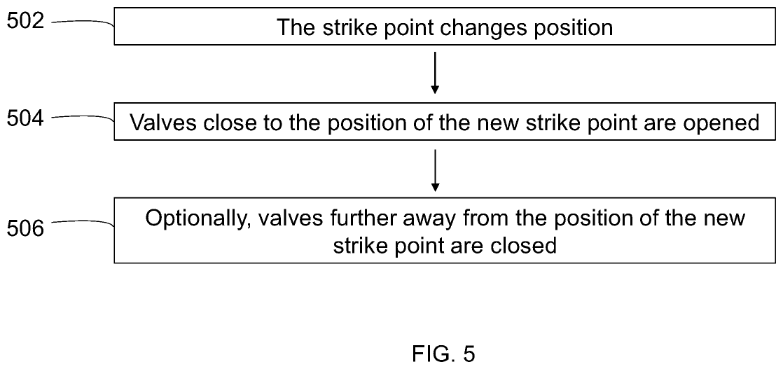

FIG. 5 shows a flow chart for evening out the temperature profile in a cooling management system 400 according to FIG. 4A to FIG. 4C.

In step 502, the strike point 412 changes position. The change in position of the strike point 412 is detected, predicted, or otherwise determined as described in more detail later.

In step 504, valves 406d-f, which are close to the position of the new strike point, are opened (either completely or opened further). The valves 406a-g may be temperature-controlled, or temperature responsive for this purpose. Opening valves 406d-f reduces the resistance to flow for each corresponding group of finger units 408e-f and increases the coolant flow rate into those groups of finger units 408d-f. Assuming the pressure difference across the cooling management system 400 remains constant, there is a corresponding reduction in the coolant flow rate into the other groups 408a-c, 408g. This evens out any undercooling in the perturbed temperature profile.

In an optional further step 506, valves 406a-b, which are further away from the position of the new strike point, are closed (either completely or closed further). This increases the resistance to flow for these groups 408a-b and decreases the coolant flow rate (or stops altogether) into those groups 408a-b. This further evens out the overcooling in the perturbed temperature profile. Step 506 may be used as an alternative or in addition to step 504.

Preferably, but not necessarily, the increase in flow rate of coolant into each group 408d-f is related to the increase in temperature (e.g. above a first predetermined temperature) for that group 408d-f. For example, this can be achieved by opening valve 406e to a greater extent than valves 406d, 406f.

Preferably, but not necessarily, the decrease in flow rate into each group 408a-b is related to the decrease in temperature (e.g. below the first or a second predetermined temperature) for that group 408a-b. For example, this can be achieved by closing valve 406a to a greater extent than valve 406b.

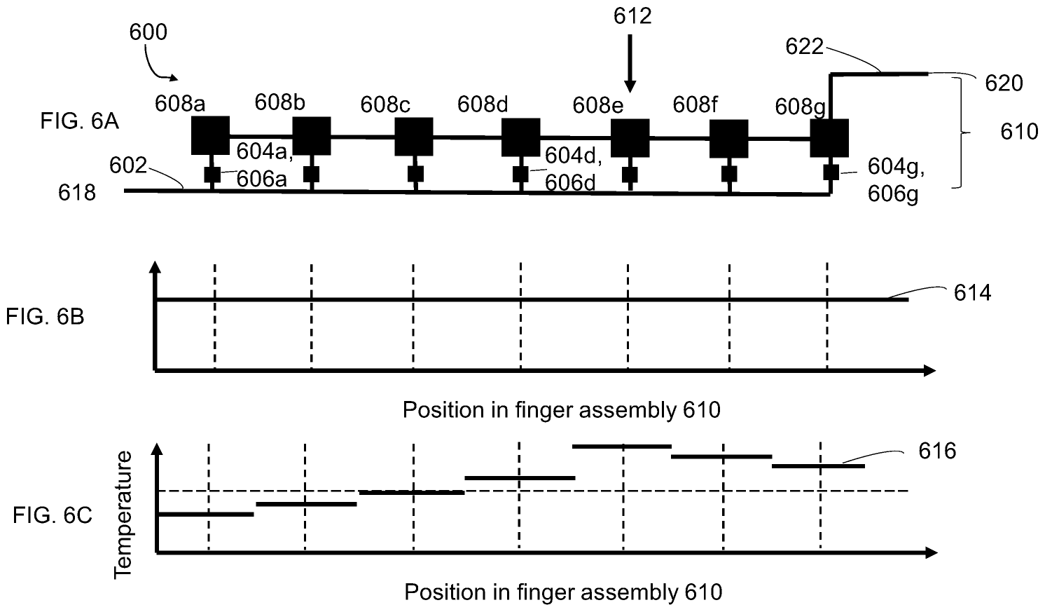

FIG. 6A shows a schematic illustration of a vertical cross section of another cooling management system 600 for a divertor. The cooling management system 600 substantially corresponds to the cooling management system 400 of FIG. 4A, except the group of finger units 608a-g are fluidly connected in series with one another, such that coolant may pass between adjacent groups of finger units 608a-g. In an alternative arrangement (not shown in FIG. 6A), the plurality of conduits 604a-g are configured to fluidly connect each group of finger units 608a-g to the outlet 620 of the cooling management system 600 (rather than from the inlet 618 via channel 602). Correspondingly valves 606a-g are arranged within these conduits to control the flow rate from the corresponding group of finger units 608a-g to the outlet 620. The inlet 618 is also referred to as a coolant source line.

As has been set out above in relation to FIG. 4, the temperature profile 614 along the finger assembly 610 is perturbed as the strike point 612 on the divertor changes. An exemplary initial temperature profile 614 and perturbed temperature profile 616 are shown in FIGS. 6B and 6C.

As the group of finger units 608a-g are fluidly connected in series, the temperature profile 616 may be asymmetric about the strike point 612, skewed in the direction of coolant flow. This is because the coolant heats up further and dissipates heat as it flows through the group of finger units 608a-g connected in series. In the example shown, group of finger units 608a-b decrease in temperature and are “overcooled”, whereas group of finger units 608d-g are “undercooled”. The temperature in the group of finger units 608c remains largely unchanged. It is noted that, in this example, the temperature in the group 608g furthest downstream from the strike point 612 in the finger assembly 600 increases, despite the fact that the divertor tiles in that group 608g may not necessarily experience an increased heat load from the plasma (cf to temperature profile in FIG. 4C).

When the group of finger units 608a-g are connected in series, the resistances to flow add. Hence, the resistance to flow for coolant (between the inlet 618 and outlet 620 of the cooling management system 600) through more groups of finger units 608a-g is larger than through fewer groups of finger units 608a-g.

On the other hand, each conduit may define a more direct fluid path, so the resistance to flow through each conduit 604a-g may be much smaller than the resistance to flow through each group of finger units 608a-g.

As such, opening a valve 606a-g from a closed state in a conduit 604a-g creates a bypass for coolant from channel 602 to the group of finger units 608a-g to which the conduit 604a-g fluidly connects, i.e. allowing fluid to throw through the low resistance conduit and bypass some groups of finger units. This bypass has lower resistance to flow (compared to a path that passes through more group of finger units 608a-g) and therefore the flowrate of coolant to groups 608a-g located upstream of the valve decreases, whereas the flowrate of coolant to groups 608a-g located downstream of the valve increases.

For example, if initially only valve 606c is open, coolant flows from the channel 602 through conduit 604c and the group of finger units 608c-g to the outlet 620. If, in response to a perturbation in the temperature profile, valve 606e is opened, then a bypass from channel 602 to group of finger units 608e is created. Coolant then flows from the channel 602 through the conduit 604e and the group of finger units 608e-g to the outlet 620, bypassing group of finger units 608a-d. Hence, the flowrate of coolant in those groups 608c-d (upstream) decreases, whereas the flowrate of coolant to groups 608e-g (downstream) increases.

Conversely, closing a valve 606a-g (completely or almost completely) has the effect of shutting/closing off the bypass, increasing the flow rate of coolant through groups located upstream of the valve 606a-g.

In other examples (not shown in FIG. 6A), conduits 604a-g fluidly connect each group of finger units 608a-g to the outlet 620 of the cooling management system 600 (rather than being on the inlet side). In these examples, opening a valve 606a-g arranged inside these conduits 604a-g achieves substantially the same effect in that it generates a bypass (i.e., low resistance) path for coolant to flow directly to the outlet 620 of the cooling management system 600. In these examples, the flowrate of coolant to groups 608a-g located further downstream decreases, whereas the flowrate of coolant to groups 608a-g located upstream increases.

Optionally, each group of finger units 608a-g comprises equal resistance to flow. As set out above, this may achieved if each group of finger units 608a-g has the same number of equivalent finger units 314, 316, 318, or, where, there are a different number of finger units 314, 316, 318 in each group with differing size and/or configuration.

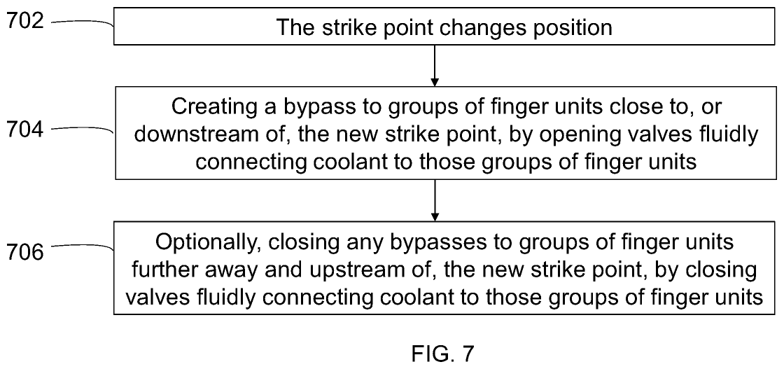

FIG. 7 shows a flow chart for evening out the temperature profile in a cooling management system 600 according to FIG. 6A to FIG. 6C.

In step 702, the strike point 612 changes position. The change in position of the strike point 612 is detected, predicted, or otherwise determined (as described in more detail later).

In step 704, valves 606d-g, which are close to (606d-e), or downstream of (606f-g), the position of the new strike point, are opened from a closed state in order to create a low-resistance bypass for coolant to the corresponding finger units to which they fluidly connect. If the valves 606d-g were already in an open state, the valves 606d-g may be opened further. Assuming the pressure difference across the cooling management system 600 remains constant, there is a corresponding reduction in the coolant flow rate into the other groups 608a-c. This evens out any undercooling in the perturbed temperature profile.

In an optional further step 706, valves 606a-c, which are further away, and upstream of, the position of the new strike point, are closed (either completely or closed further). In this way, low resistance bypasses to those corresponding groups 608a-c are closed and the coolant flow rate to groups 608d-g increases. This further evens out the perturbed temperature profile.

The valves 606a-g may be temperature-controlled or temperature responsive.

It is noted that, if valves 606d-g are equally open (or such that their resistance to flow is equal) then coolant may also bypass groups 608d-f because the resistance to flow of conduit 604g may generally be much smaller than the resistance to flow of group of finger units 608d-f. This behaviour is sub-optimal because coolant bypasses group of finger units which require greater cooling.

In this regard, it is desirable that valves 606b-g (excluding valve 606a) are calibrated to open above a first predetermined temperature, wherein the first predetermined temperature corresponds to the expected temperature in a group of finger units 608a-g located beneath the strike point 612. In an example, the first predetermined temperature is 350 to 450° C. The first predetermined temperature can be calculated using known modelling techniques with the temperature of the divertor target plate being between 1250 to 1500° C. In such a scenario, only group of finger units 606e may be above the first predetermined temperature and therefore, initially, only valve 606e opens, whereas valves 606d, 606f initially remain closed (they are below the first predetermined temperature). In this way, the flow rate of coolant to group 608e (and those groups downstream of group 608e) increases and coolant is not bypassed from group 608e.

Alternatively, valves 606b-g are configured with sufficiently high resistances to flow, such that, when the valves 606b-g (excluding valve 606a, which provides coolant to the group of finger units 608 located furthest upstream in the cooling management system 600) are open they act like throttles. Hence, valves 606b-g define a relatively high resistance path for coolant through conduits 604b-g. In such cases, valves 606b-g supplement coolant flow to particular groups 608b-g, rather than setting up a bypass for coolant, per se. In this approach, the flow rate into each group 608e, 608d, 608f can be controlled (to some extent) by controlling the relative throttling power of each valves 606e, 606f, 606g.

It has been shown that the cooling management systems 400, 600 can control the flow rate of coolant to even out the perturbed temperature profile 416, 616 by opening and/or closing valves 406a-g, 606a-g. The valves may either be active (temperature-controlled) or passive (temperature-responsive).

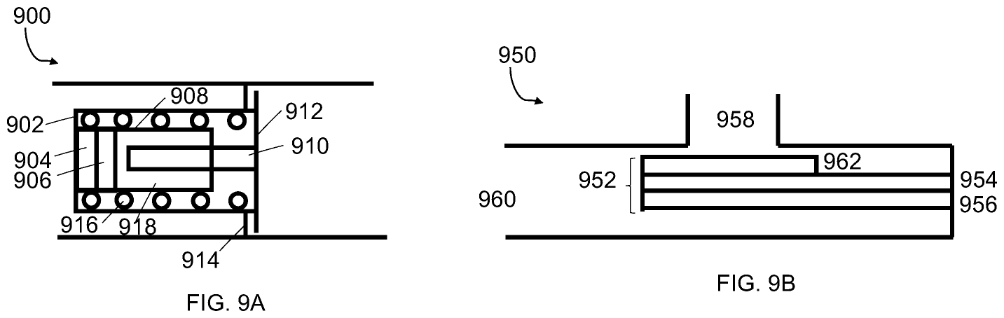

A passive valve is configured to respond to the in-situ temperature of fluid (e.g., coolant), which is in local fluid communication with the valve. Exemplary passive valves are described in further detail below, with reference to FIGS. 9A and 9B.

Active values are operable to open and close (completely or to a greater extent) using a controller. The instructions provided by the controller may be determined by analysing diagnostic measurements in the tokamak. The diagnostic measurement may be, for example, a temperature measurement from one or more temperature sensors located within each conduit 404a-g, 604a-g. Alternatively, plasma-related diagnostics may be used to predict an expected temperature in the cooling management system. Any diagnostic measurement in a tokamak known to the skilled reader from which temperature can be determined is suitable for this purpose.

In particularly harsh environments, active control is unpractical because of the limited lifetime of electronic equipment (e.g., electronically switchable valves). In such environments, passive control (e.g., passive valves) is a more practical solution.

In this regard, the passive valves 406a-g, 606a-g may be calibrated to remain closed below a first predetermined temperature and be fully open above a second predetermined temperature. Between the first and second predetermined temperatures, the resistance to flow of the valve decreases monotonically. In some examples, the second predetermined temperature is larger than the first predetermined temperature. For example, the first predetermined temperature is 350 to 450° C. and the second predetermined temperature is 550 to 650° C. In other examples, the passive valves 406a-g, 606a-g are configured to switch between a closed and open state at a single temperature, for example, 500° C. Further detail regarding the structure and type of the passive valve suitable for the cooling management system 400 is provided in FIGS. 9A and B.

In the cooling management systems 400, 600 illustrated in FIG. 4 and FIG. 6, the finger assembly 410, 610 have seven groups of finger units 408a-g, 608a-g. However, as the skilled reader would appreciate, the number of the groups of finger units in a finger assembly 410, 610 may be different.

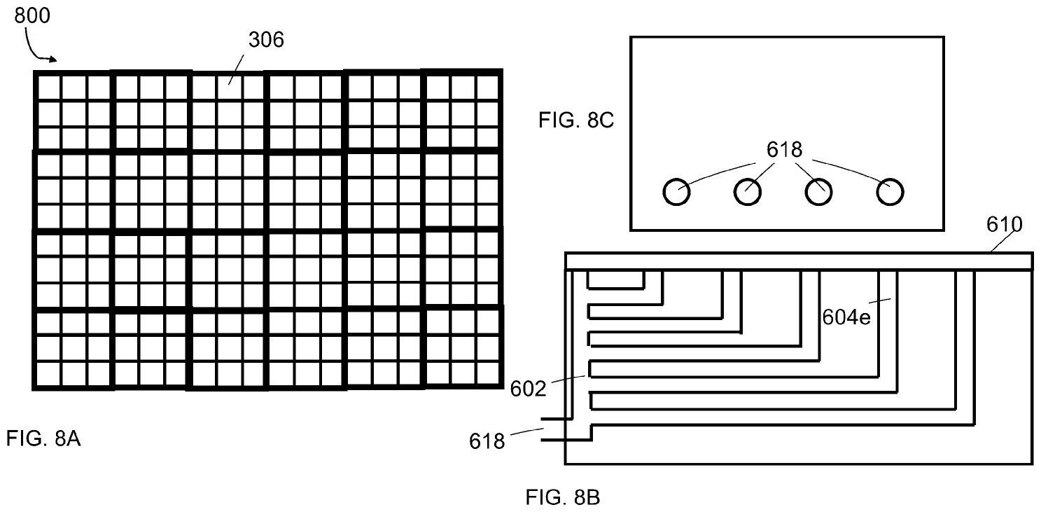

FIG. 8A, B, C illustrates a schematic view of each cross section of a cooling management system.

FIG. 8A shows a schematic illustration of a top-down view of cooling management system, showing a divertor surface 600 comprising a plurality of tessellating divertor tiles 306. In the example shown, the divertor tiles 306 are shown to be square in shape, but as the skilled reader would appreciate other tessellating shapes are possible, for example, hexagons. In other examples, the divertor tiles 306 may not necessarily be the same shape or size. As an example, each side of the divertor tile 306 may be 3 mm to 10 mm, e.g. 6 mm. Other sizes are possible.

FIG. 8B shows a schematic illustration of a first vertical cross section of a cooling management system (equivalent to that shown in FIG. 5A), which is configured to provide coolant to the divertor surface 800 of FIG. 8A via the finger assembly 610. Further detail of the finger assembly is provided in FIG. 6 and is not repeated here. In FIG. 8B there are six conduits 604a-g and six groups of finger units. Comparing with FIG. 8A, each group of finger units 608a-g comprises three finger units in the longitudinal direction.

FIG. 8C shows a schematic illustration of a second vertical cross-section of a cooling management system (equivalent to that shown in FIG. 5A), comprising a plurality of inlets 618. Each inlet 618 is configured to provide coolant to a particular finger assembly 610 (See, FIG. 8B). In FIG. 8C, there are four inlets 618 and therefore each group of finger units 608a-g comprises a three by three array of finger units, and the divertor comprises a twelve by eighteen array of divertor tiles 306. For illustrative purposes only, these groups are highlighted in FIG. 8A, however they do not reflect an actual physical feature of the divertor surface 800.

In a specific example, where the divertor is used in a plasma confinement system, the size of the divertor may be set according to the size of the plasma confinement system, and in particular the expected range of locations for plasma strike points.

In general, each finger unit 314, 316, 318 may comprise a portion of, or, one or more divertor tiles 306.

The number of finger units 314, 316, 318 in each group of finger units 408a-g, 608a-g may be set according to the “expected width of the temperature peak” (e.g, the full-width-half-maximum) in the temperature profile across the divertor surface. The width of the temperature peak is around 5 to 25 mm. If the group of finger units 408a-g, 608a-g is much larger than the “effective width” of the temperature increase in the finger assembly 410, 610, then “excess” coolant is provided over a larger area (the group of finger units 408a-g, 608a-g) than necessary (expected width of temperature peak). Where the group of finger units 408a-g, 608a-g are much smaller than the “effective width” of the temperature increase in the finger assembly 410, 610, control of coolant is more complex, requiring a large number of conduits 404a-g, 604a-g. In a specific example, the group of finger units 408a-g, 608a-g may comprise a 5 by 5 array of 6 mm-sized finger units 314, 316, 318 wherein each finger unit 314, 316, 318 comprises one divertor tile 306 to match the expected width of the temperature peak

The number of groups of finger units to a finger assembly may therefore be set by the size of each group of finger units and the required size of the divertor surface.

As has already been noted, each finger unit may be integrally formed to a portion of a tile of the divertor, or to one or more of the tiles of the divertor. Each group of finger units may therefore define an array of tiles on the divertor. In a specific example, as an alternative to setting the number of finger units by the expected width of the temperature peak, the array may be 10 to 100 tiles wide and 10 to 100 tiles in length. The number of finger units 314, 316, 318 in each group 408a-g; 608a-g may be in the range 100 to 10000, more preferably, 1000 to 5000.

The number of finger units in each group may be set by various design considerations, such as the internal environment of the plasma confinement system the system is to be implemented in, including variables such as power deposition, heat flux profile, and strike point stability. In general larger groups will simplify the construction of the divertor system, whereas smaller groups will allow a more fine-grained response of the divertor to changes in the strike point, generally allowing increased efficiency of the system (as the area which needs to be cooled sufficiently for the full heat of the strike point will be smaller)

The number of inlets (or coolant source lines) in the cooling management system may be set according to various design considerations, for example the size of each group of finger units, the required size of the divertor surface and the design needs of the pumping system. In an example, there are two or more inlets (and therefore two or more coolant source lines) that provide coolant to the finger assembly in parallel. Each finger assembly may comprise 2 to 100 groups of finger units, more preferably 3 to 25, even more preferably, 3 to 10 groups of finger units.

The coolant in the cooling management system may be a (pressurised) liquid or a gas. In an example, the coolant may be pressurised water. In another example, the coolant may be helium gas.

FIGS. 9A and 9B show schematic illustrations of exemplary passive valves for the cooling management systems of FIG. 4 and FIG. 6.

In FIG. 9A, the passive valve 900 comprises an expandable-element thermostat, which is well-known to the skilled reader. The passive valve comprises: a valve housing 902; one or more expandable elements 904, 906 (e.g., a wax element) sealed using sealant 918 within a column 908 located in the valve housing 902; a rod or pin 910, wherein one end of the rod or pin 910 is mechanically coupled to the column 908 and the other end of the rod or pin 910 comprises a cap 912; a valve seat 914; and a biasing element 916 (e.g., a spring) configured to urge cap 912 against the valve seat 914.

In some examples, the one or more expandable elements 904, 906 are disposed on the finger assembly 410, 610 side of the cooling management system, such that the expandable elements 904, 906 may reach thermal equilibrium with the finger assembly 410, 610 more effectively. In other examples, the one or more expandable elements 904, 906 are disposed on the conduit 404a-g, 604a-g side of the cooling management system.

The expandable elements 904, 906 are configured such that, at temperatures below the first predetermined temperature, the biasing element 916 (e.g., spring) is sufficiently stiff enough to essentially maintain a seal between cap 912 and the valve seat 914. The seal may not necessarily be “fluid-tight”, but, preferably, the seal should significantly restrict flow through the valve. That is, below the first predetermined temperature, the passive valve 900 is essentially closed and coolant cannot pass around the passive valve 900 or, at the very least, flow of coolant through the passive valve 900 is significantly restricted.

On the other hand, the biasing element 916 (e.g., spring) is sufficiently compliant such that, when the expandable elements 904, 906 heat up above the first predetermined temperature and expand, they 904, 906 are able to urge the cap 912 (via the rod 910) away from the valve seat 914. This causes the valve seat 914 and cap 912 to separate (to a greater extent), thereby defining a lower resistance path for coolant to flow around the passive valve 900.

In some examples, the one or more expandable elements 904, 906 are solid and are configured to undergo a phase transition (i.e. melt) during heating. The melting temperature may correspond to the second predetermined temperature because melting leads to significant expansion.

In some examples, the one or more expandable elements 904, 906 have different melting points and therefore melt at different temperatures. In such cases, the one or more expandable elements 704, 706 may be arranged in series with one another in the column 908, such that melting of each of the expandable elements 904, 906 with different melting point leads to a corresponding step change in the separation between cap 912 and valve seat 914. In these examples, the second predetermined temperature corresponds to the highest melting point of the one or more expandable elements 904, 906.

When the expandable elements 904, 906 are solid, the change in separation between valve seat 914 and cap 912 is proportional to the change in temperature. Such a passive valve 900 would be suitable for controlling the flow rate of coolant into the cooling management system 400 of FIG. 4. However, the change in separation between the valve seat 914, and cap 912 would be relatively small compared to a valve 700 that uses expandable elements which melt. In that respect, the valve 900 may be more suitable as a throttle for the cooling management system 600 of FIG. 6. Nevertheless, mechanical levers can be used to magnify this relatively small displacement, if required.

When the expandable elements 904, 906 have melting points between the first and second predetermined temperature (e.g., at the second predetermined temperature), then the resistance of the valve 900 to flow may drastically reduce at these melting points. The “second predetermined temperature” can therefore be set according to the melting point of the expandable elements 904, 906. Such a passive valve 900 may be especially suitable for the cooling management system 600 of FIG. 6, which generates bypasses for coolant to the group of finger units 608a-g. However, such a passive valve 900 would also be suitable for the cooling management system 400 of FIG. 4.

In FIG. 9B, the passive valve 950 comprises a structure 952 of at least two materials 954, 956 with differing thermal expansion coefficients. The passive valve is arranged within the conduits 404a-g, 604a-g. An example of the structure is a bimetallic strip, which is well-known to the skilled reader. As the structure is heated, the differential between the thermal expansion of the different materials leads to bending. For example, in FIG. 9B, if material 954 exhibits a higher thermal expansion than material 956, then the structure 952 bends away from the outlet 958 to open the valve as the temperature increases. This actuation can be used to close and/or open the valve 950. Optionally, a seal 962 is disposed on the structure 952 configured to form a fluid tight seal with outlet 958. In some examples, the outlet 958 shown in FIG. 9B corresponds to the either the inlet (i.e., as shown in FIG. 4 and FIG. 6) or the outlet of the group of finger units 408a-g, 608a-g (i.e., the alternative option described for FIG. 6, where conduits 606a-g are fluidly connected to the outlet of each group of finger units 608a-g). Correspondingly, the inlet 960 shown in FIG. 9B corresponds either to the channel 402, 602 or the outlet 620 of the cooling management system 600. In FIG. 9B, the structure 950 is fixed at one end within the conduit 404a-g, 604a-g to which it is disposed. In other examples, the structure 950 may be fixed at both ends.

In a specific example, the cooling management system is used for a tokamak or a stellarator. The materials comprising the structure may be chosen such that corrosion is limited, or negligible during operation of the cooling management system 400, 600 (e.g., using water as a coolant, the sandwich structure may be, for example, formed from a material combination selected from: stainless steel, Invar, aluminium-bronze and titanium. The displacement of the structure is proportional to the change in temperature and the differential between the thermal expansion coefficients of the at least two materials 954, 956. Such a passive valve 950 is therefore especially suitable for controlling the flow rate of coolant into the cooling management system 400 of FIG. 4 because the resistance to flow of the valve 950 changes proportionally with temperature. The passive valve 950 is also suitable for the cooling management system 600 of FIG. 6.

Unless explicitly stated to the contrary, references to a valve being opened and closed means relative to a previous state. A valve may be opened from a closed state, but may equally be opened further from an already “open state”. Similarly, a valve may be closed from a “completely” open state, or may be closed further from a partially open state.

An example of the cooling management system described above is summarised below.

The example provides for a cooling management system for a plasma-facing assembly in a magnetic confinement plasma chamber, the cooling management system comprising: a coolant unit assembly, the coolant unit assembly comprising: a plurality of groups, each of the groups comprising one or more coolant units, each coolant unit comprising a coolant channel configured to provide coolant to a respective area of the plasma facing assembly, each group further comprising a conduit configured to supply coolant to the one or more coolant units; and a valve, arranged within each conduit, operable to control the flow rate of coolant into each group of the coolant unit assembly.

The plurality of groups in the cooling management system may be either connected in series or connected in parallel.

The valves in the cooling management system may be either passive or active.

Actively controlled valves can be controlled using a controller configured to actuate each valve further closed or open depending on the temperature. That is, the controller may be configured to further close the valve monotonically between a second predetermined temperature and a first predetermined temperature, or, further open the valve monotonically between the first predetermined temperature and the second predetermined temperature to vary its flow resistance.

The state of the passive valves may depend on temperature. That is, each valve is configured to open monotonically as the temperature increases from a first predetermined temperature to a second predetermined temperature to decrease the flow resistance of the valve; and close monotonically as the temperature decreases from a second predetermined temperature to a first predetermined temperature to increase the flow resistance of the valve.

The first predetermined temperature may be around 350 to 450° C. and the second predetermined temperature may be around 550 to 650° C.

Optionally, each passive valve comprises one or more stacked expandable elements, having a melting point substantially equal to the second predetermined temperature, such that, when said expandable elements melt, a cap, attached to one end of a rod which is mechanically coupled to said expandable elements, is urged away from a valve seat to open the valve.

Alternatively, each passive valve comprises a structure comprising at least two materials with differing thermal expansion coefficients, wherein the structure is arranged to obstruct flow through the valve to a greater degree at lower temperatures.

Each valve may be located close to the inlet of the corresponding group.

The plasma-facing assembly may be a divertor assembly and each coolant unit may be integrally formed to a portion of a tile of a divertor, or one or more of the tiles of a divertor. Each group may comprise between 100 to 10,000 coolant units, more preferably, 1000 to 5000 coolant units and each group may define an array of tiles on the divertor, the array comprising 10 to 100 divertor tiles along a first transverse direction and 10 to 100 divertor tiles along a second transverse direction.

The cooling management system may further comprise two or more channels operable to provide coolant in parallel to a different set of the groups of the coolant unit assembly and each set of groups of the coolant unit assembly may comprise 3 to 10 groups.

In a complimentary example, there is provided a tokamak or stellarator comprising the cooling management system described in the above summarised example.

The tokamak may be a spherical tokamak, and more preferably a spherical tokamak having an aspect ratio of less than or equal to 2.5, the aspect ratio being defined as the ratio of the major and minor radii of a toroidal plasma-confining region of the tokamak.

Although the invention has been described in terms of preferred embodiments as set forth above, it should be understood that these embodiments are illustrative only and that the claims are not limited to those embodiments. Features from different examples may be combined as appropriate to form other working examples

[symbol]

1. A cooling management system for a plasma-facing assembly in a magnetic confinement plasma chamber, the cooling management system comprising:
a plurality of coolant unit groups, each configured to provide cooling to a respective part of the plasma-facing assembly and being fluidly connected to a coolant source line; and
a valve arrangement operable to control a flow rate of coolant from the coolant source line to each of the coolant unit groups dependent on the temperature at that coolant unit group.

2. The cooling management system according to claim 1, wherein each of the coolant unit groups comprises a conduit configured to supply coolant to its one or more coolant units and each coolant unit comprises a coolant channel configured to provide coolant to a respective area of said part of the plasma facing assembly.

3. The cooling management system according to claim 2, wherein the valve arrangement comprises a valve arranged within the conduit of each coolant group.

4. The cooling management system according any preceding claim, wherein the plurality of groups are fluidly connected in series.

5. The cooling management system according to any preceding claim, wherein the plurality of groups are fluidly connected in parallel.

6. The cooling management system according to any of claims 3 to 5, further comprising a controller configured to actuate each valve further closed and open monotonically between a first and a second predetermined temperature to vary the flow resistance of the valve.

7. The cooling management system according to any of claims 3 to 5, wherein each valve is passive.

8. The cooling management system according to claim 7, wherein each valve is configured to:
open as the temperature increases from a first predetermined temperature to a second predetermined temperature to monotonically decrease the flow resistance of the valve; and
close as the temperature decreases from a second predetermined temperature to a first predetermined temperature to monotonically increase the flow resistance of the valve.

9. The cooling management system according to claim 8, wherein each valve comprises one or more stacked expandable elements, having a melting point substantially equal to the second predetermined temperature, such that, when said expandable elements melt, a cap, attached to one end of a rod which is mechanically coupled to said expandable elements, is urged away from a valve seat to open the valve.

10. The cooling management system according to claim 8, wherein each valve comprises a structure comprising at least two materials with differing thermal expansion coefficients, wherein the structure is arranged to obstruct flow through the valve to a greater degree at lower temperatures.

11. The cooling management system according to any one of claims 6, or 8 to 10 , wherein the first predetermined temperature is 350 to 450° C. and the second predetermined temperature is 550 to 650°C.

12. The cooling management system according to any of claims 3 to 11, wherein each valve is located close to the inlet of the corresponding group.

13. The cooling management system according to any preceding claim, wherein the plasma-facing assembly is a divertor assembly.

14. The cooling management system according to any of claims 2 to 13, wherein, each of the coolant units is integrally formed to a portion of a tile of a divertor, or one or more of the tiles of a divertor.

15. The cooling management system according to claim 14, wherein each group comprises 100 to 10,000 coolant units, more preferably, 1000 to 5000 coolant units.

16. The cooling management system according to claim 14 or 15, wherein each group defines an array of tiles on the divertor, the array comprising 10 to 100 divertor tiles along a first transverse direction and 10 to 100 divertor tiles along a second transverse direction.

17. The cooling management system according to any preceding claim, further comprising one or more coolant source lines operable to provide coolant in parallel to a different set of the groups of the coolant unit assembly.

18. The cooling management system according to claim 17, wherein each set of groups of the coolant unit assembly comprises 3 to 100 groups.

19. A tokamak comprising the cooling management system according to any of claims 1 to 18.

20. The tokamak according to claim 18, wherein the tokamak is a spherical tokamak, and more preferably a spherical tokamak having an aspect ratio of less than or equal to 2.5, the aspect ratio being defined as the ratio of the major and minor radii of a toroidal plasma-confining region of the tokamak

21. A stellarator comprising the cooling management system according to any of claims 1 to 18.
